(19) United States
(12) Patent Application Publication
(10) Pub. No.: US 2009/0149313 A1
(43) Pub. Date: Jun. 11, 2009

(54) Mixed Matrix Membranes Containing Low Acidity Nano-Sized SAPO-34 Molecular Sieves

(76) Inventors: Chunqing Liu, Schaumburg, IL (US); Stephen T. Wilson, Libertyville, IL (US); Lisa M. Knight, Chicago, IL (US)

Correspondence Address: HONEYWELL INTERNATIONAL INC;PATENT SERVICES, 101 COLUMBIA DRIVE, P O BOX 2245 MAIL STOP AB/2B, MORRISTOWN, NJ, 07962, US

(21) Appl. No.: 11/954,017

(22) Filed: Dec. 11, 2007

(51) Int. Cl. B01J 20/28

(52) U.S. Cl. 502/4

(57) ABSTRACT

The present invention discloses mixed matrix membranes (MMMs) containing polymer-functionalized low acidity, ultra low silica-to-alumina ratio, nano-sized SAPO-34 small pore molecular sieves and a continuous polymer matrix and methods for making and using these membranes. The surface functionalization of these molecular sieves provides a desired interfacial adhesion between SAPO-34 nano-particles and the continuous polymer matrix, which results in either no macrovoids or voids of less than 5 angstroms at the interface of the continuous polymer matrix and SAPO-34 in the MMMs. These MMMs, in the form of symmetric dense film, asymmetric flat sheet membrane, or asymmetric hollow fiber membranes, have good flexibility and high mechanical strength, and exhibit remarkably enhanced CO₂ permeability (or CO₂ permeance) and maintained CO₂/CH₄ selectivity over the continuous polymer matrices for CO₂/CH₄ separation. The MMMs of the present invention are suitable for a variety of liquid, gas, and vapor.

### BACKGROUND OF THE INVENTION

This invention pertains to novel mixed matrix membranes (MMMS) containing polymer-functionalized low acidity, low Si/Al ratio, nano-sized SAPO-34 small pore molecular sieves and a continuous polymer matrix.

Current commercial cellulose acetate (CA) polymer membranes for natural gas upgrading must be improved to maintain their competitiveness in this industry. It is highly desirable to provide an alternate cost-effective new membrane with higher selectivity and permeability than CA membrane for CO₂/CH₄ and other gas and vapor separations.

Gas separation processes with membranes have undergone a major evolution since the introduction of the first membrane-based industrial hydrogen separation process about two decades ago. The design of new materials and efficient methods will further advance the membrane gas separation processes within the next decade.

The gas transport properties of many glassy and rubbery polymers have been measured as part of the search for materials with high permeability and high selectivity for potential use as gas separation membranes. Unfortunately, an important limitation in the development of new membranes for gas separation applications is a well-known trade-off between permeability and selectivity of polymers. By comparing the data of hundreds of different polymers, Robeson demonstrated that selectivity and permeability seem to be inseparably linked to one another, in a relation where selectivity increases as permeability decreases and vice versa.

Despite concentrated efforts to tailor polymer structure to improve separation properties; current polymeric membrane materials have seemingly reached a limit in the trade-off between productivity and selectivity. For example, many polyimide and polyetherimide glassy polymers such as Ultem® 1000 have much higher intrinsic CO₂/CH₄ selectivities (α_{CO2/CH4}) (˜30 at 50° C. and 690 kPa (100 psig) pure gas tests) than that of cellulose acetate (˜22), which are more attractive for practical gas separation applications. These polymers, however, do not have outstanding permeabilities attractive for commercialization compared to current commercial cellulose acetate membrane products, in agreement with the trade-off relationship reported by Robeson. On the other hand, some inorganic membranes such as SAPO-34 and carbon molecular sieve membranes offer much higher permeability and selectivity than polymeric membranes for separations, but are expensive and difficult for large-scale manufacture. Therefore, it is highly desirable to provide an alternate cost-effective membrane with improved separation properties and in a position above the trade-off curves between permeability and selectivity.

Based on the need for a more efficient membrane than polymer and inorganic membranes, a new type of membrane, mixed matrix membranes (MMMs), has been developed recently. MMMs are hybrid membranes containing inorganic fillers such as molecular sieves dispersed in a polymer matrix.

Mixed matrix membranes have the potential to achieve higher selectivity with equal or greater permeability compared to existing polymer membranes, while maintaining their advantages such as low cost and easy processability. Much of the research conducted to date on mixed matrix membranes has focused on the combination of a dispersed solid molecular sieving phase, such as molecular sieves or carbon molecular sieves, with an easily processed continuous polymer matrix. For example, see U.S. Pat. No. 6,626,980; US 2005/0268782; US 2007/0022877; and U.S. Pat. No. 7,166,146. The sieving phase in a solid/polymer mixed matrix scenario can have a selectivity that is significantly larger than the pure polymer. Therefore, in theory the addition of a small volume fraction of molecular sieves to the polymer matrix will increase the overall separation efficiency significantly. Typical inorganic sieving phases in MMMs include various molecular sieves, carbon molecular sieves, and traditional silica. Many organic polymers, including cellulose acetate, polyvinyl acetate, polyetherimide (commercially Ultem®), polysulfone (commercial Udel®), polydimethylsiloxane, polyethersulfone, and several polyimides (including commercial Matrimid®), have been used as the continuous phase in MMMs.

While the polymer “upper-bound” curve has been surpassed using solid/polymer MMMs, there are still many issues that need to be addressed for large-scale industrial production of these new types of MMMs. For example, for most of the molecular sieve/polymer MMMs reported in the literature, voids and defects at the interface of the inorganic molecular sieves and the organic polymer matrix were observed due to poor interfacial adhesion and poor materials compatibility. These voids, that are much larger than the penetrating molecules, resulted in reduced overall selectivity of the MMMs. Research has shown that the interfacial region, which is a transition phase between the continuous polymer and dispersed sieve phases, is of particular importance in forming successful MMMs.

Most recently, significant research efforts have been focused on materials compatibility and adhesion at the inorganic molecular sieve/polymer interface of the MMMs in order to achieve separation property enhancements over traditional polymers. For example, Kulkami et al. and Marand et al. reported the use of organosilicon coupling agent functionalized molecular sieves to improve the adhesion at the sieve particle/polymer interface of the MMMs. See U.S. Pat. No. 6,508,860 and U.S. Pat. No. 7,109,140. This method, however, has a number of drawbacks including: 1) prohibitively expensive organosilicon coupling agents; 2) very complicated time consuming molecular sieve purification and organosilicon coupling agent recovery procedures after functionalization. Therefore, the cost of making such MMMs having organosilicon coupling agent functionalized molecular sieves in a commercially viable scale can very expensive. Most recently, Kulkami et al. also reported the formation of MMMs with minimal macrovoids and defects by using electrostatically stabilized suspensions. See US 2006/0117949.

US 2005/0139065 A1 to Miller et al., entitled “Mixed matrix membranes with low silica-to-alumina ratio molecular sieves and methods for making and using the membranes”, reports the incorporation of low silica-to-alumina (Si/Al) ratio molecular sieves into a polymer membrane with a Si/Al molar ratio of the molecular sieves preferably less than 1.0. Miller et al. claim that when the low Si/Al ratio molecular sieves are properly interspersed with a continuous polymer matrix, the MMM ideally will exhibit improved gas separation performance even without functionalizing the surface of the molecular sieves using organosilicon coupling agent.

The present invention discloses the use of low acidity, ultra low Si/Al ratio, nano-sized SAPO-34 small pore molecular sieves with nanometer particle size (≦500 nm) and excellent molecular sieving separation property (e.g., for CO₂/CH₄ separation) in MMMs. Our experimental results showed that MMMs incorporating the low acidity, ultra low Si/Al molar ratio (Si/Al≦0.15), nano-sized SAPO-34 molecular sieves remarkably enhanced CO₂ permeability (or CO₂ permeance) and maintained CO₂/CH₄ selectivity over the continuous polymer matrices for CO₂/CH₄ separation. It was found that higher acidity, higher Si/Al molar ratio (Si/Al≧0.18), nano-sized SAPO-34 molecular sieves reacted with and therefore partially decomposed some polymer matrices (e.g., polyimides and polyamides). The MMMs made from these high acidity SAPO molecular sieves showed significantly decreased CO₂/CH₄ selectivity for CO₂/CH₄ gas separation compared to the membranes made from the corresponding polymer matrices.

### SUMMARY OF THE INVENTION

This invention pertains to novel voids and defects free mixed matrix membranes (MMMs) containing polymer-functionalized low acidity, ultra low Si/Al ratio, nano-sized SAPO-34 small pore molecular sieves.

The present invention discloses novel polymer-functionalized low acidity, ultra low Si/Al ratio, nano-sized SAPO-34/polymer MMMs with either no macrovoids or voids of less than 5 angstroms at the interface of the polymer matrix and SAPO-34 molecular sieves. These MMMs were prepared by incorporating polymer (e.g., polyethersulfone) functionalized low acidity, ultra low Si/Al ratio, nano-sized SAPO-34 into a continuous polymer (e.g., polyimide) matrix. These MMMs in the form of symmetric dense film, thin-film composite, asymmetric flat sheet membrane, or asymmetric hollow fiber membranes fabricated by the method described in the current invention have good flexibility and high mechanical strength, and exhibit significantly enhanced CO₂ permeability (or CO₂ permeance) and maintained CO₂/CH₄ selectivity over the polymer membranes made from the corresponding continuous polymer matrices for CO₂/CH₄ separation.

The present invention provides a novel method of making voids and defects free nano-sized SAPO-34/polymer MMMs, using stable polymer-functionalized nano-sized SAPO-34/polymer suspensions (or so-called “casting dope”) containing dispersed polymer-functionalized low acidity, ultra low Si/Al ratio, nano-sized SAPO-34 particles and a dissolved continuous polymer matrix in a mixture of organic solvents. The method comprises: (a) dispersing the low acidity, ultra low Si/Al ratio, nano-sized SAPO-34 particles in a mixture of two or more organic solvents by ultrasonic mixing and/or mechanical stirring or other method to form a molecular sieve slurry; (b) dissolving a suitable polymer in SAPO-34 slurry to functionalize the surface of SAPO-34 nano-particles; (c) dissolving a polymer that serves as a continuous polymer matrix in the polymer-functionalized SAPO-34 slurry to form a stable polymer-functionalized SAPO-34/polymer suspension; (d) fabricating a MMM in a form of symmetric dense film, thin-film composite, asymmetric flat sheet, or asymmetric hollow fiber using this polymer-functionalized SAPO-34/polymer suspension.

In some cases a membrane post-treatment step can be added to improve selectivity without changing or damaging the membrane, or causing the membrane to lose performance with time. The membrane post-treatment step can involve coating the top surface of the MMM with a thin layer of material such as a polysiloxane, a fluoro-polymer, a thermally curable silicone rubber, or a UV radiation curable silicone rubber.

The molecular sieve material in the MMMs provided in this invention is crystalline low acidity, ultra low Si/Al molar ratio, nano-sized SAPO-34 small pore microporous silicoaluminophosphate molecular sieve having a Si/Al molar ratio ≦0.15 and particle size ≦500 nm. Control of the ultra low Si content in SAPO-34 described in the current invention is achieved by direct hydrothermal synthesis of ultra low Si/Al molar ratio SAPO-34 from low Si content reactive precursor mixtures. The ultra low Si/Al ratio, nano-sized SAPO-34 molecular sieves described in the present invention have advantageous nano particle size of ≦500 nm, low acidity or no acidity (e.g., AlPO-34), which significantly reduces or completely prevents the reaction between the polymer matrix and the molecular sieves under acidic conditions in the MMMs. Therefore, MMMs are formed free of voids and defects. In addition, the outside surface of the SAPO-34 particles dispersed in the MMMs is functionalized by a suitable polymer which has good compatibility (or miscibility) with the continuous polymer matrix (e.g., polyethersulfone (PES) can be used to functionalize the outside surface of SAPO-34 nano-particles when Matrimid polyimide is used as the continuous polymer matrix in the MMM). The surface functionalization of SAPO-34 particles results in the formation of polymer-O—Al, polymer-O—P, and polymer-O—Si (if Si is present) covalent bonds via reactions between the hydroxyl (—OH) groups on the outside surfaces of the low acidity, ultra low Si/Al ratio, SAPO-34 particles and the functional groups (e.g., hydroxyl (—OH) groups) at the polymer chain ends or at the polymer side chains. The surface functionalization of SAPO-34 particles can also result from the formation of hydrogen bonds between the hydroxyl groups on the outside surfaces of SAPO-34 and the functional groups such as ether groups on the polymer chains. The functionalization of the surfaces of SAPO-34 using a suitable polymer provides good compatibility and an interface substantially free of voids and defects at SAPO-34/polymer matrix interface. Therefore, polymer-functionalized SAPO-34/polymer MMMs free of voids and defects and with significant separation property enhancements over traditional polymer membranes have been successfully prepared.

The stabilized suspension contains polymer-functionalized low acidity, ultra low Si/Al ratio, nano-sized SAPO-34 particles uniformly dispersed in a continuous polymer matrix. The MMM, particularly symmetric dense film MMM, thin-film composite MMM, asymmetric flat sheet MMM, or asymmetric hollow fiber MMM, is fabricated from the stabilized suspension. A MMM prepared by the present invention comprises uniformly dispersed polymer-functionalized SAPO-34 nano-particles throughout the continuous polymer matrix. The continuous polymer matrix is selected from a glassy polymer such as a polyimide. The polymer used to functionalize SAPO-34 particles is selected from a polymer either the same as or different from the polymer matrix.

The method of the current invention for producing voids and defects free, high performance MMMs is suitable for large scale membrane production and can be integrated into commercial polymer membrane manufacturing processes.

The invention provides a process for separating at least one gas from a mixture of gases using the MMMs described in the present invention, the process comprising: (a) is providing a MMM comprising a polymer-functionalized low acidity, ultra low Si/Al ratio, SAPO-34 nano-particles uniformly dispersed in a continuous polymer matrix which is permeable to said at least one gas; (b) contacting the mixture on one side of the MMM to cause said at least one gas to permeate the MMM; and (c) removing from the opposite side of the membrane a permeate gas composition comprising a portion of said at least one gas which permeated said membrane.

The SAPO-34/polymer MMMs of the present invention are suitable for a variety of liquid, gas, and vapor separations such as deep desulfurization of gasoline and diesel fuels, ethanol/water separations, pervaporation dehydration of aqueous/organic mixtures, CO₂/CH₄, CO₂/N₂, H₂/CH₄, O₂/N₂, olefin/paraffin, iso/normal paraffins separations, and other light gas mixture separations.

### DETAILED DESCRIPTION OF THE INVENTION

Mixed matrix membrane (MMM) containing dispersed molecular sieve fillers in a continuous polymer matrix may retain polymer processability and improve selectivity for separations due to the superior molecular sieving and sorption properties of the molecular sieve materials. The MMMs have received worldwide attention during the last two decades. For most cases, however, aggregation of the molecular sieve particles in the polymer matrix and the poor adhesion at the interface of molecular sieve particles and the polymer matrix in MMMs that result in poor mechanical and processing properties and poor permeation performance still need to be addressed. Material compatibility and good adhesion between the polymer matrix and the molecular sieve particles are needed to achieve enhanced selectivity of the MMMs. Poor adhesion that results in voids and defects around the molecular sieve particles that are larger than the pores inside the molecular sieves decrease the overall selectivity of the MMM by allowing the species to be separated to bypass the pores of the molecular sieves. Thus, the MMMs can only at most exhibit the selectivity of the continuous polymer matrix.

US 2005/0139065 A1 to Miller et al., entitled “Mixed matrix membranes with low silica-to-alumina ratio molecular sieves and methods for making and using the membranes”, reports the incorporation of low silica-to-alumina (Si/Al) ratio molecular sieves into a polymer membrane with a Si/Al molar ratio of the molecular sieves preferably less than 1.0. Miller et al. claim that when the low Si/Al ratio molecular sieves are properly interspersed with a continuous polymer matrix, the MMM ideally will exhibit improved gas separation performance even without functionalizing the surface of the molecular sieves using organosilicon coupling agent. Our experimental results, however, demonstrated that SAPO-34 molecular sieve with Si/Al=0.187 reacted with and therefore partially decomposed some polymer matrices (e.g., polyimides and polyamides). Therefore, the MMMs made from this SAPO-34 molecular sieve with Si/Al=0.187 showed major defects and no CO₂/CH₄ selectivity.

The present invention pertains to novel mixed matrix membranes (MMMs) containing polymer-functionalized low acidity, ultra low silica-to-alumina ratio (Si/Al≦0.15), nano-sized SAPO-34 (particle size≦500 nm) small pore molecular sieves and a continuous polymer matrix and methods for making and using these membranes. The surface functionalization of the low acidity, ultra low Si/Al ratio, nano-sized SAPO-34 provides a desired interfacial adhesion between SAPO-34 nano-particles and the continuous polymer matrix, which results in either no macrovoids or voids of less than several angstroms at the interface of the continuous polymer matrix and SAPO-34 in the MMMs. These MMMs, in the form of symmetric dense film, thin-film composite, asymmetric flat sheet membrane, or asymmetric hollow fiber membranes, have good flexibility and high mechanical strength, and exhibit remarkably enhanced CO₂ permeability (or CO₂ permeance) and maintained CO₂/CH₄ selectivity over the continuous polymer matrices for CO₂/CH₄ separation. The MMMs of the present invention are suitable for a variety of liquid, gas, and vapor separations such as deep desulfurization of gasoline and diesel fuels, ethanol/water separations, pervaporation dehydration of aqueous/organic mixtures, CO₂/CH₄, CO₂/N₂, H₂/CH₄, O₂/N₂, olefin/paraffin, iso/normal paraffins separations, and other light gas mixture separations.

The MMMs of the current invention are prepared by using stabilized concentrated suspensions (also called “casting dope”) containing uniformly dispersed polymer-functionalized SAPO-34 nano-particles and a continuous polymer matrix. The term “mixed matrix” as used in this invention means that the membrane has a selective permeable layer which comprises a continuous polymer matrix and discrete polymer-functionalized SAPO-34 nano-particles uniformly dispersed throughout the continuous polymer matrix. The terms “nano-sized” and “nano-particle” as used in this invention mean that the particle size is ≦500 nm. The term “small pore” refers to molecular sieves which have less than or equal to 8-ring openings in their framework structure.

The present invention provides a novel method of making voids and defects free polymer-functionalized low acidity, ultra low Si/Al ratio, nano-sized SAPO-34/polymer MMMs. The MMMs were prepared by using stable polymer-functionalized SAPO-34/polymer suspensions (or so-called “casting dope”) containing dispersed polymer-functionalized low acidity, ultra low Si/Al ratio, nano-sized SAPO-34 particles and a dissolved continuous polymer matrix in a mixture of organic solvents. The method comprises: (a) dispersing the low acidity, ultra low Si/Al ratio, nano-sized SAPO-34 particles in a mixture of two or more organic solvents by ultrasonic mixing and/or mechanical stirring or other method to form a molecular sieve slurry; (b) dissolving a suitable polymer in the molecular sieve slurry to functionalize the surface of SAPO-34 particles; (c) dissolving a polymer that serves as a continuous polymer matrix in the polymer-functionalized SAPO-34 slurry to form a stable polymer-functionalized SAPO-34/polymer suspension; (d) fabricating a MMM in a form of symmetric dense film, asymmetric flat sheet, or asymmetric hollow fiber using this polymer-functionalized SAPO-34/polymer suspension.

In some cases, a membrane post-treatment step can be added to improve selectivity but does not change or damage the membrane, or cause the membrane to lose performance with time. The membrane post-treatment step can involve coating the top surface of the MMM with a thin layer of material such as a polysiloxane, a fluoro-polymer, a thermally curable silicone rubber, or a UV radiation curable epoxy silicone rubber.

Molecular sieve materials are microporous crystals with pores of a well-defined size ranging from about 0.2 to 2 nm. This discrete porosity provides molecular sieving properties to these materials which have found wide applications as catalysts and sorption media. Molecular sieves have framework structures which may be characterized by distinctive wide-angle X-ray diffraction patterns. Molecular sieve structure types can be identified by their structure type code as assigned by the IZA Structure Commission following the rules set up by the IUPAC Commission on Zeolite Nomenclature. SAPO-34 is a non-zeolitic CHA type small pore microporous molecular sieve based on silicoaluminophosphate composition.

To date, almost all of the studies on mixed matrix membranes use large commercially available molecular sieve particles with particle sizes in the micron range. See Yong, et al., J. MEMBR. SCI., 188:151 (2001); U.S. Pat. No. 5,127,925; U.S. Pat. No. 4,925,562; U.S. Pat. No. 4,925,459; and US 2005/0043167 A1. However, commercially available polymer membranes such as cellulose acetate and polysulfone membranes have an asymmetric structure with a thin selective layer. As a consequence, the minimal selective layer thickness of the mixed matrix membranes should be inherently higher than that of most unfilled membranes and the absolute fluxes would be low. Therefore, large molecular sieve particles in micrometer range are unsuitable for the development of commercially attractive mixed matrix membranes. Template-free molecular sieve nano-particles are required for the development of mixed matrix membranes. Nano-sized molecular sieves have been developed recently, which leads to the possibility to prepare thin, defect-free, filled polymer layers. See Persson, et al., Zhu, et al., CHEM. MATER., 10:1483 (1998); Ravishankar, et al., J. PHYS. CHEM., 102:2633 (1998); Huang, et al., J. AM. CHEM. SOC., 122:3530 (2000). As an example, Brown et al. reported the synthesis of nano-sized SAPO-34 molecular sieve having a cubic-like crystal morphology with edges of less than 100 nm. See Brown et al., US 2004/0082825 A1 (2004). Vankelecom et al. reported the first incorporation of nano-sized zeolites in membranes by dispersing colloidal silicalite-1 in polydimethylsiloxane polymer membrane. See Moermans, et al., CHEM. COMMUN., 2467 (2000). Homogeneous polymer-zeolite mixed matrix membranes were also fabricated by the incorporation of dispersible template-removed zeolite A nanocrystals into polysulfone matrix. See Yan, et al., J. MATER. CHEM., 12:3640 (2002).

The current invention reports the incorporation of low acidity, ultra low Si/Al ratio nano-sized SAPO-34 small pore molecular sieves into polymer membranes. Control of the ultra low Si content in SAPO-34 described in the current invention is achieved by direct hydrothermal synthesis of ultra low Si/Al ratio SAPO-34 from low Si content reactive precursor solution following the literature procedure. See Brown et al., US 2004/0082825 A1 (2004) incorporated herein in its entirety.

The nano-sized SAPO-34 of this invention is capable of separating mixtures of molecular species based on the molecular size or kinetic diameter (molecular sieving mechanism). The separation is accomplished by the smaller molecular species entering the intracrystalline void space while excluding larger species. The kinetic diameters of various molecules such as oxygen (O₂), nitrogen (N₂), carbon dioxide (CO₂), carbon monoxide (CO) and various hydrocarbons are provided in Breck, Zeolite Molecular Sieves, John Wiley and Sons, 1974, p. 636.

The low acidity, ultra low Si/Al ratio nano-sized SAPO-34 small pore molecular sieves of this invention improve the performance of the MMM by including selective holes/pores with a size that permits a smaller gas molecule to pass through, but either does not permit another larger gas molecule to pass through, or permits it to pass through at a significantly slower rate.

The particle size of the low acidity, ultra low Si/Al ratio SAPO-34 small pore molecular sieve particles dispersed in the continuous polymer matrix of the MMMs in the present invention should be small enough to form a uniform dispersion of the particles in the concentrated suspensions from which the MMMs will be fabricated. The median particle size of SAPO-34 should be less than 500 nm, preferably less than 250 nm, and more preferably less than 100 nm. The low acidity, ultra low Si/Al ratio SAPO-34 small pore molecular sieve particles described in the present invention should be easily dispersed without agglomeration in the polymer matrix to maximize the transport property.

The ultra low Si/Al ratio, nano-sized SAPO-34 molecular sieves described in the present invention have advantageous nano particle size of ≦500 nm, low acidity or no acidity (e.g., AlPO-34), which significantly reduces or completely prevents the reaction between the polymer matrix and the molecular sieves under acidic conditions in the MMMs. Therefore, voids and defects free MMMs are formed. In addition, the outside surface of the SAPO-34 particles dispersed in the MMMs is functionalized by a suitable polymer which has good compatibility (or miscibility) with the continuous polymer matrix (e.g., polyethersulfone (PES) can be used to functionalize the outside surface of SAPO-34 nano-particles when Matrimid polyimide is used as the continuous polymer matrix in the MMM). The surface functionalization of SAPO-34 particles results in the formation of polymer-O—Al, polymer-O—P, and polymer-O—Si (if Si is present) covalent bonds via reactions between the hydroxyl (—OH) groups on the outside surfaces of the low acidity, ultra low Si/Al ratio, SAPO-34 nano-particles and the functional groups (e.g., hydroxyl (—OH) groups) at the polymer chain ends or at the polymer side chains. The surface functionalization of SAPO-34 particles can also results in the formation of hydrogen bonds between the hydroxyl groups on the outside surfaces of SAPO-34 and the functional groups such as ether groups on the polymer chains. The functionalization of the surfaces of SAPO-34 using a suitable polymer provides good compatibility and an interface substantially free of voids and defects at SAPO-34/polymer matrix interface. Therefore, voids and defects free polymer-functionalized SAPO-34/polymer MMMs with significant separation property enhancements over traditional polymer membranes have been successfully prepared.

The functions of the polymers used to functionalize SAPO-34 nano-particles in the MMMs of the present invention include: 1) forming good adhesion at SAPO-34/polymer interface via hydrogen bonds or SAPO-34-O-polymer covalent bonds; 2) being an intermediate to improve the compatibility of SAPO-34 with the continuous polymer matrix; 3) stabilizing SAPO-34 nano-particles in the concentrated suspensions to remain homogeneously suspended. Any polymer that has these functions and also has good compatibility (or miscibility) with the continuous polymer matrix can be used to functionalize SAPO-34 nano-particles in the concentrated suspensions from which MMMs are formed. Preferably, the polymers used to functionalize SAPO-34 contain functional groups such as hydroxyl or amino groups that can form hydrogen bonding with the hydroxyl groups on the surfaces of the molecular sieves. More preferably, the polymers used to functionalize SAPO-34 contain functional groups such as hydroxyl or isocyanate groups that can react with the hydroxyl groups on the surface of SAPO-34 to form polymer-O—SAPO-34 covalent bonds. Thus, good adhesion between SAPO-34 nano-particles and polymer is achieved. Representatives of such polymers are hydroxyl or amino group-terminated or ether polymers such as polyethersulfones (PESs), sulfonated PESs, poly(vinyl esters) such as poly(vinyl acetate) and poly(vinyl propionate), poly(vinyl ether)s, polyethers such as hydroxyl group-terminated poly(ethylene oxide)s, amino group-terminated poly(ethylene oxide)s, or isocyanate group-terminated poly(ethylene oxide)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), polyether ketones, poly(ethylene imine)s, poly(amidoamine)s, poly(vinyl alcohol)s, poly(vinyl acetate)s, poly(allyl amine)s, poly(vinyl amine)s, and polyetherimides such as Ultem (or Ultem 1000) sold under the trademark Ultem®, manufactured by Sabic Innovative Plastics, as well as hydroxyl group-containing glassy polymers such as cellulosic polymers including cellulose acetate, cellulose triacetate, cellulose acetate-butyrate, cellulose propionate, ethyl cellulose, methyl cellulose, and nitrocellulose.

The weight ratio of SAPO-34 to the polymer used to functionalize SAPO-34 in the MMMs of the current invention can be within a broad range, but not limited to, from about 1:2 to 100:1 based on the polymer used to functionalize SAPO-34, i.e. 50 weight parts of SAPO-34 per 100 weight parts of polymer used to functionalize SAPO-34 to about 100 weight parts of SAPO-34 per 1 weight part of polymer used to functionalize SAPO-34 depending upon the properties sought as well as the dispersibility of SAPO-34 in a particular suspension. Preferably the weight ratio of SAPO-34 to the polymer used to functionalize SAPO-34 in the MMMs of the current invention is in the range from about 10:1 to 1:2.

The stabilized suspension contains polymer-functionalized SAPO-34 nano-particles uniformly dispersed in the continuous polymer matrix. The MMM, particularly dense film MMM, thin-film composite MMM, asymmetric flat sheet MMM, or asymmetric hollow fiber MMM, is fabricated from the stabilized suspension. The MMM prepared by the present invention comprises uniformly dispersed polymer-functionalized low acidity, ultra low Si/Al ratio, SAPO-34 nano-particles throughout the continuous polymer matrix. The polymer that serves as the continuous polymer matrix in the MMM of the present invention provides a wide range of properties important for separations, and modifying it can improve membrane selectivity. A material with a high glass transition temperature (Tg), high melting point, and high crystallinity is preferred for most gas separations. Glassy polymers (i.e., polymers below their Tg) have stiffer polymer backbones and therefore let smaller molecules such as hydrogen and helium permeate the membrane more quickly and larger molecules such as hydrocarbons permeate the membrane more slowly. For the MMM applications in the present invention, it is preferred that the membrane fabricated from the pure polymer, which can be used as the continuous polymer matrix in MMMs, exhibits a carbon dioxide over methane selectivity of at least about 8, more preferably at least about 15 at 50° C. and 690 kPa (100 psig) pure carbon dioxide or methane testing pressure. Preferably, the polymer that serves as the continuous polymer matrix in the MMM of the present invention is a rigid, glassy polymer. The weight ratio of the molecular sieves to the polymer that serves as the continuous polymer matrix in the MMM of the current invention can be within a broad range from about 1:100 (1 weight part of molecular sieves per 100 weight parts of the polymer that serves as the continuous polymer matrix) to about 1:1 (100 weight parts of molecular sieves per 100 weight parts of the polymer that serves as the continuous polymer matrix) depending upon the properties sought as well as the dispersibility of SAPO-34 nano-particles in the particular continuous polymer matrix.

Typical polymer that serves as the continuous polymer matrix in the MMM can be selected from, but is not limited to, polysulfones; sulfonated polysulfones; polyethersulfones (PESs); sulfonated PESs; polyethers; polyetherimides such as Ultem (or Ultem 1000) sold under the trademark Ultem®, manufactured by Sabic Innovative Plastics; polycarbonates; cellulosic polymers, such as cellulose acetate, cellulose triacetate, cellulose acetate-butyrate, cellulose propionate, ethyl cellulose, methyl cellulose, nitrocellulose; polyamides; polyimides such as Matrimid sold under the trademark Matrimid® by Huntsman Advanced Materials (Matrimid® 5218 refers to a particular polyimide polymer sold under the trademark Matrimid®) and P84 or P84HT sold under the tradename P84 and P84HT respectively from HP Polymers GmbH; polyamide/imides; polyketones, polyether ketones; poly(arylene oxides) such as poly(phenylene oxide) and poly(xylene oxide); poly(esteramide-diisocyanate); polyurethanes; polyesters (including polyarylates), such as poly(ethylene terephthalate), poly(alkyl methacrylates), poly(acrylates), poly(phenylene terephthalate), etc.; polysulfides; polymers from monomers having alpha-olefinic unsaturation other than mentioned above such as poly(ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol)s, poly(vinyl ester)s such as poly(vinyl acetate) and poly(vinyl propionate), poly(vinyl pyridine)s, poly(vinyl pyrrolidone)s, poly(vinyl ether)s, poly(vinyl ketone)s, poly(vinyl aldehyde)s such as poly(vinyl formal) and poly(vinyl butyral), poly(vinyl amide)s, poly(vinyl amine)s, poly(vinyl urethane)s, poly(vinyl urea)s, poly(vinyl phosphate)s, and poly(vinyl sulfate)s; polyallyls; poly(benzobenzimidazole)s; polybenzoxazoles; polyhydrazides; polyoxadiazoles; polytriazoles; poly(benzimidazole)s; polycarbodiimides; polyphosphazines; microporous polymers; and interpolymers, including block interpolymers containing repeating units from the above such as terpolymers of acrylonitrile-vinyl bromide-sodium salt of para-sulfophenylmethallyl ethers; and grafts and blends containing any of the foregoing. Typical substituents providing substituted polymers include halogens such as fluorine, chlorine and bromine; hydroxyl groups; lower alkyl groups; lower alkoxy groups; monocyclic aryl; lower acryl groups and the like.

Some preferred polymers that can serve as the continuous polymer matrix include, but are not limited to, polysulfones, sulfonated polysulfones, polyethersulfones (PESs), sulfonated PESs, poly(vinyl alcohol)s, polyetherimides such as Ultem (or Ultem 1000) sold under the trademark Ultem®, manufactured by Sabic Innovative Plastics, cellulosic polymers such as cellulose acetate and cellulose triacetate, polyamides; polyimides such as Matrimid sold under the trademark Matrimid® by Huntsman Advanced Materials (Matrimid® 5218 refers to a particular polyimide polymer sold under the trademark Matrimid®), P84 or P84HT sold under the tradename P84 and P84HT respectively from HP Polymers GmbH, poly(3,3′,4,4′-benzophenone tetracarboxylic dianhydride-pyromellitic dianhydride-3,3′,5,5′-tetramethyl-4,4′-methylene dianiline) (poly(BTDA-PMDA-TMMDA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (poly(DSDA-TMMDA),), poly(3,3′,4,4′-benzophenone tetracarboxylic dianhydride-3,3′,5,5′-tetramethyl-4,4′-methylene dianiline) (poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), poly[2,2′-bis-(3,4-dicarboxyphenyl)hexafluoropropane dianhydride-1,3-phenylenediamine] (poly(6FDA-m-PDA)), poly[2,2′-bis-(3,4-dicarboxyphenyl)hexafluoropropane dianhydride-1,3-phenylenediamine-3,5-diaminobenzoic acid)] (poly(6FDA-m-PDA-DABA)); poly[2,2′-bis-(3,4-dicarboxyphenyl)hexafluoropropane dianhydride-2,2-bis(3-amino-4-hydroxyphenyl)-hexafluoropropane] (poly(6FDA-bis-AP-AF)); polyamide/imides; polyketones, polyether ketones; and microporous polymers.

The most preferred polymers that can serve as the continuous polymer matrix include, but are not limited to, polyimides such as Matrimid®, P84200 , poly(BTDA-PMDA-TMMDA), poly(BTDA-PMDA-ODPA-TMMDA), poly(DSDA-TMMDA), poly(BTDA-TMMDA), poly(6FDA-bis-AP-AF), or poly(DSDA-PMDA-TMMDA), polyetherimides such as Ultem®, polyethersulfones, polysulfones, cellulose acetate, cellulose triacetate, poly(vinyl alcohol)s, polybenzoxazoles, and microporous polymers.

Microporous polymers (or as so-called “polymers of intrinsic microporosity”) described herein are polymeric materials that possess microporosity that is intrinsic to their molecular structures. See McKeown, et al., CHEM. COMMUN., 2780 (2002); Budd, et al., ADV. MATER., 16:456 (2004); McKeown, et al., CHEM. EUR. J., 11:2610 (2005). This type of microporous polymers can be used as the continuous polymer matrix in MMMs in the current invention. The microporous polymers have a rigid rod-like, randomly contorted structure to generate intrinsic microporosity. These microporous polymers exhibit behavior analogous to that of conventional microporous molecular sieve materials, such as large and accessible surface areas, interconnected intrinsic micropores of less than 2 nm in size, as well as high chemical and thermal stability, but, in addition, possess properties of conventional polymers such as good solubility and easy processability. Moreover, these microporous polymers possess polyether polymer chains that have favorable interaction between carbon dioxide and the ethers.

The solvents used for dispersing the low acidity, ultra low Si/Al ratio, SAPO-34 nano-particles in the concentrated suspension and for dissolving the polymer used to functionalize SAPO-34 and the polymer that serves as the continuous polymer matrix are chosen primarily for their ability to completely dissolve the polymers and for ease of solvent removal in the membrane formation steps. Other considerations in the selection of solvents include low toxicity, low corrosive activity, low environmental hazard potential, availability and cost. Representative solvents for use in this invention include most amide solvents that are typically used for the formation of polymeric membranes, such as N-methylpyrrolidone (NMP) and N,N-dimethyl acetamide (DMAC), methylene chloride, THF, acetone, DMF, DMSO, toluene, dioxanes, 1,3-dioxolane, mixtures thereof, others known to those skilled in the art and mixtures thereof.

In the present invention, MMMs can be fabricated with various membrane structures such as mixed matrix dense films, asymmetric flat sheet MMMs, asymmetric thin film composite MMMs, or asymmetric hollow fiber MMMs from the stabilized concentrated suspensions containing a mixture of solvents, polymer-functionalized SAPO-34, and a continuous polymer matrix. For example, the suspension can be sprayed, spin coated, poured into a sealed glass ring on top of a clean glass plate, or cast with a doctor knife. In another method, a porous substrate can be dip coated or cast with the suspension. One solvent removal technique used in the present invention is the evaporation of volatile solvents by ventilating the atmosphere above the forming membrane with a diluent dry gas and drawing a vacuum. Another solvent removal technique used in the present invention calls for immersing the cast thin layer of the concentrated suspension (previously cast on a glass plate or on a porous or permeable substrate) in a non-solvent for the polymers that is miscible with the solvents of the suspension. To facilitate the removal of the solvents, the substrate and/or the atmosphere or non-solvent into which the thin layer of dispersion is immersed can be heated. When the MMM is substantially free of solvents, it can be detached from the glass plate to form a free-standing (or self-supporting) structure or the MMM can be left in contact with a porous or permeable support substrate to form an integral composite assembly. Additional fabrication steps that can be used include washing the MMM in a bath of an appropriate liquid to extract residual solvents and other foreign matters from the membrane, drying the washed MMM to remove residual liquid, and in some cases coating a thin layer of material such as a polysiloxane, a fluoro-polymer, a thermally curable silicone rubber, or a UV radiation curable epoxy silicone to fill the surface voids and defects on the MMM. One preferred embodiment of the current invention is in the form of an asymmetric flat sheet MMM for gas separation comprising a smooth thin dense selective layer on top of a highly porous supporting layer. No major voids and defects on the top surface were observed. The back electron image (BEI) of the flat sheet asymmetric MMM showed that the polymer-functionalized molecular sieve particles were uniformly distributed from the top dense layer to the porous support layer.

The method of the present invention for producing high performance MMMs is suitable for large scale membrane production and can be integrated into commercial polymer membrane manufacturing process. The MMMs, particularly dense film MMMs, thin-film composite MMMs, asymmetric flat sheet MMMs, or asymmetric hollow fiber MMMs, fabricated by the method described in the current invention exhibit significantly enhanced selectivity and/or permeability over polymer membranes prepared from their corresponding polymer matrices and over those prepared from suspensions containing the same polymer matrix and SAPO-34 but without polymer functionalization.

The current invention provides a process for separating at least one gas from a mixture of gases using the MMMs described in the present invention, the process comprising: (a) providing a MMM comprising polymer-functionalized low acidity, ultra low Si/Al ratio, SAPO-34 nano-particles uniformly dispersed in a continuous polymer matrix which is permeable to said at least one gas; (b) contacting the mixture on one side of the MMM to cause said at least one gas to permeate the MMM; and (c) removing from the opposite side of the membrane a permeate gas composition comprising a portion of said at least one gas which permeated said membrane.

The MMMs of the present invention are suitable for a variety of gas, vapor, and liquid separations, and particularly suitable for gas and vapor separations such as separations of CO₂/CH₄, H₂/CH₄, O₂/N₂, CO₂/N₂, olefin/paraffin, and iso/normal paraffins.

The MMMs of the present invention are especially useful in the purification, separation or adsorption of a particular species in the liquid or gas phase. In addition to separation of pairs of gases, these MMMs may, for example, be used for the separation of proteins or other thermally unstable compounds, e.g. in the pharmaceutical and biotechnology industries. The MMMs may also be used in fermenters and bioreactors to transport gases into the reaction vessel and transfer cell culture medium out of the vessel. Additionally, the MMMs may be used for the removal of microorganisms from air or water streams, water purification, ethanol production in a continuous fermentation/membrane pervaporation system, and in detection or removal of trace compounds or metal salts in air or water streams.

The MMMs of the present invention are especially useful in gas separation processes in air purification, petrochemical, refinery, and natural gas industries. Examples of such separations include separation of volatile organic compounds (such as toluene, xylene, and acetone) from an atmospheric gas, such as nitrogen or oxygen and nitrogen recovery from air. Further examples of such separations are for the separation of CO₂ from natural gas, H₂ from N₂, CH₄, and Ar in ammonia purge gas streams, H₂ recovery in refineries, olefin/paraffin separations such as propylene/propane separation, and iso/normal paraffin separations. Any given pair or group of gases that differ in molecular size, for example nitrogen and oxygen, carbon dioxide and methane, hydrogen and methane or carbon monoxide, helium and methane, can be separated using the MMMs described herein. More than two gases can be removed from a third gas. For example, some of the gas components which can be selectively removed from a raw natural gas using the membrane described herein include carbon dioxide, oxygen, nitrogen, water vapor, hydrogen sulfide, helium, and other trace gases. Some of the gas components that can be selectively retained include hydrocarbon gases.

The MMMs described in the current invention are also especially useful in gas/vapor separation processes in chemical, petrochemical, pharmaceutical and allied industries for removing organic vapors from gas streams, e.g. in off-gas treatment for recovery of volatile organic compounds to meet clean air regulations, or within process streams in production plants so that valuable compounds (e.g., vinylchloride monomer, propylene) may be recovered. Further examples of gas/vapor separation processes in which these MMMs may be used are hydrocarbon vapor separation from hydrogen in oil and gas refineries, for hydrocarbon dew pointing of natural gas (i.e. to decrease the hydrocarbon dew point to below the lowest possible export pipeline temperature so that liquid hydrocarbons do not separate in the pipeline), for control of methane number in fuel gas for gas engines and gas turbines, and for gasoline recovery. The MMMs may incorporate a species that adsorbs strongly to certain gases (e.g. cobalt porphyrins or phthalocyanines for O₂ or silver(I) for ethane) to facilitate their transport across the membrane.

These MMMs may also be used in the separation of liquid mixtures by pervaporation, such as in the removal of organic compounds (e. g., alcohols, phenols, chlorinated hydrocarbons, pyridines, ketones) from water such as aqueous effluents or process fluids. A membrane which is ethanol-selective would be used to increase the ethanol concentration in relatively dilute ethanol solutions (5-10% ethanol) obtained by fermentation processes. Another liquid phase separation example using these MMMs is the deep desulfurization of gasoline and diesel fuels by a pervaporation membrane process similar to the process described in U.S. Pat. No. 7,048,846, incorporated by reference herein in its entirety. The MMMs that are selective to sulfur-containing molecules would be used to selectively remove sulfur-containing molecules from fluid catalytic cracking (FCC) and other naphtha hydrocarbon streams. Further liquid phase examples include the separation of one organic component from another organic component, e. g. to separate isomers of organic compounds. Mixtures of organic compounds which may be separated using an inventive membrane include: ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether,ethanol-ethylbutylether, propylacetate-propanol, isopropylether-isopropanol, methanol-ethanol-isopropanol, and ethylacetate-ethanol-acetic acid.

The MMMs may be used for separation of organic molecules from water (e.g. ethanol and/or phenol from water by pervaporation) and removal of metal and other organic compounds from water.

An additional application of the MMMs is in chemical reactors to enhance the yield of equilibrium-limited reactions by selective removal of a specific product in an analogous fashion to the use of hydrophilic membranes to enhance esterification yield by the removal of water.

The present invention pertains to novel voids and defects free polymer-functionalized SAPO-34/polymer mixed matrix membranes (MMMs) fabricated from stable concentrated suspensions containing uniformly dispersed polymer-functionalized low acidity, ultra low Si/Al ratio, SAPO-34 nano-particles and the continuous polymer matrix. These new MMMs have immediate applications for the separation of gas mixtures including carbon dioxide removal from natural gas. MMM permits carbon dioxide to diffuse through at a faster rate than the methane in the natural gas. Carbon dioxide has a higher permeation rate than methane because of higher solubility, higher diffusivity, or both. Thus, carbon dioxide enriches on the permeate side of the membrane, and methane enriches on the feed (or reject) side of the membrane.

### EXAMPLES

The following examples are provided to illustrate one or more preferred embodiments of the invention, but are not limited embodiments thereof. Numerous variations can be made to the following examples that lie within the scope of the invention.

### Example 1

### Preparation of “Control” poly(DSDA-PMDA-TMMDA)-PES (Abbreviated as Control 1) Polymer Membrane

3.0 g of poly(DSDA-PMDA-TMMDA) polyimide polymer and 3.0 g of polyethersulfone (PES) were dissolved in a solvent mixture of NMP and 1,3-dioxolane by mechanical stirring for 2 hours to form a homogeneous casting dope. The resulting homogeneous casting dope was allowed to degas overnight. A Control 1 blend polymer membrane was prepared from the bubble free casting dope on a clean glass plate using a doctor knife with a 20-mil gap. The membrane together with the glass plate was then put into a vacuum oven. The solvents were removed by slowly increasing the vacuum and the temperature of the vacuum oven. Finally, the membrane was dried at 200° C. under vacuum for at least 48 hours to completely remove the residual solvents to form Control 1.

### Example 2

### Preparation of Control 30% nano-SAPO-34(Si/Al=0.187)/PES/poly(DSDA-PMDA-TMMDA) Mixed Matrix Membrane (Abbreviated as Control MMM 1)

A Control 30% nano-SAPO-34(Si/Al=0.187)/PES/poly(DSDA-PMDA-TMMDA) mixed matrix membrane (abbreviated as Control MMM 1) containing 30 wt % of dispersed SAPO-34 nano-particles with a Si/Al molar ratio of 0.187 in poly(DSDA-PMDA-TMMDA) polyimide continuous matrix was prepared as follows: 1.8 g of SAPO-34(Si/Al=0.187) nano-particles synthesized according to the literature procedure (See Brown et al., US 2004/0082825 A1 (2004)) were dispersed in a mixture of 11.6 g of NMP and 17.2 g of 1,3-dioxolane by mechanical stirring and ultrasonication for 1 hour to form a slurry. Then 0.6 g of PES was added to functionalize SAPO-34(Si/Al=0.187) nano-particles in the slurry. The slurry was stirred for at least 1 hour to completely dissolve PES polymer and functionalize the surface of SAPO-34. After that, 3.0 g of poly(DSDA-PMDA-TMMDA) polyimide polymer and 2.4 g of PES polymer were added to the slurry and the resulting mixture was stirred for another 2 hours to form a stable casting dope containing 30 wt % of dispersed PES functionalized SAPO-34(Si/Al=0.187) nano-particles (weight ratio of SAPO-34 to poly(DSDA-PMDA-TMMDA) and PES is 30:100; weight ratio of PES to poly(DSDA-PMDA-TMMDA) is 1:1) in the continuous poly(DSDA-PMDA-TMMDA) and PES blend polymer matrix. The stable casting dope was allowed to degas overnight.

A Control MMM 1 mixed matrix membrane was prepared on a clean glass plate from the bubble free stable casting dope using a doctor knife with a 20-mil gap. The film together with the glass plate was then put into a vacuum oven. The solvents were removed by slowly increasing the vacuum and the temperature of the vacuum oven. Finally, the membrane dried at 200° C. under vacuum for at least 48 hours to completely remove the residual solvents to form Control MMM 1.

### Example 3

### Preparation of 30% nano-SAPO-34(Si/Al=0.09)/PES/poly(DSDA-PMDA-TMMDA) Mixed Matrix Membrane (Abbreviated as MMM 2)

A 30% nano-SAPO-34(Si/Al=0.09)/PES/poly(DSDA-PMDA-TMMDA) mixed matrix membrane (abbreviated as MMM 2) containing 30 wt % of dispersed low acidity, ultra low Si/Al molar ratio SAPO-34 nano-particles with a Si/Al molar ratio of 0.09 in poly(DSDA-PMDA-TMMDA) polyimide continuous matrix was prepared as follows:

1.8 g of low acidity, ultra low Si/Al molar ratio SAPO-34(Si/Al=0.09) nano-particles (particle size=˜270-280 nm) synthesized according to the literature procedure (See Brown et al., US 2004/0082825 A1 (2004)) were dispersed in a mixture of 11.6 g of NMP and 17.2 g of 1,3-dioxolane by mechanical stirring and ultrasonication for 1 hour to form a slurry. Then 0.6 g of PES was added to functionalize SAPO-34(Si/Al=0.09) nano-particles in the slurry. The slurry was stirred for at least 1 hour to completely dissolve PES polymer and functionalize the surface of SAPO-34. After that, 3.0 g of poly(DSDA-PMDA-TMMDA) polyimide polymer and 2.4 g of PES polymer were added to the slurry and the resulting mixture was stirred for another 2 hours to form a stable casting dope containing 30 wt % of dispersed PES functionalized SAPO-34(Si/Al=0.09) nano-particles (weight ratio of SAPO-34 to poly(DSDA-PMDA-TMMDA) and PES is 30:100; weight ratio of PES to poly(DSDA-PMDA-TMMDA) is 1:1) in the continuous poly(DSDA-PMDA-TMMDA) and PES blend polymer matrix. The stable casting dope was allowed to degas overnight.

A MMM 2 mixed matrix membrane was prepared on a clean glass plate from the bubble free stable casting dope using a doctor knife with a 20-mil gap. The film together with the glass plate was then put into a vacuum oven. The solvents were removed by slowly increasing the vacuum and the temperature of the vacuum oven. Finally, the membrane dried at 200° C. under vacuum for at least 48 hours to completely remove the residual solvents to form “control” MMM 2.

### Example 4

### CO₂/CH₄ Separation Properties of Control 1, Control MMM 1, and MMM 2 Membranes

The permeabilities (P_{CO2} and P_{CH4}) and selectivity (α_{CO2/CH4}) of Control 1 prepared in Example 1, Control MMM 1 prepared in Example 2, and MMM 2 prepared in Example 3 were measured by pure gas measurements at 50° C. under about 690 kPa (100 psig) pressure. The results for CO₂/CH₄ separation are shown in the following Table.

It can be seen from the following Table that MMM 2 mixed matrix membrane containing 30 wt % of low acidity, ultra low Si/Al molar ratio SAPO-34(Si/Al=0.09) nano-particles showed >150% enhancement in P_{CO2} and maintained α_{CO2/CH4} for CO₂/CH₄ separation compared to Control 1 polymer membrane, suggesting a successful formation of mixed matrix membrane with either no macrovoids or voids of less than 5 angstroms at the interface of SAPO-34 and the continuous poly(DSDS-PMDA-TMMDA) and PES matrix. However, Control MMM 1 mixed matrix membrane containing 30 wt % of higher acidity, higher Si/Al molar ratio SAPO-34(Si/Al=0.187) nano-particles showed major defects and voids mainly due to the serious particle aggregation in the polymer matrix, which resulted in no CO₂/CH₄ separation performance. These results suggest that SAPO-34 molecular sieve with low acidity, ultra low Si/Al molar ratio (Si/Al=0.09), and small particle size (˜270-280 nm) used in Example 3 is a suitable filler material for making defect-free mixed matrix membranes.

Pure gas permeation test results of Control 1, Control
MMM 1, and MMM 2 for CO₂/CH₄ separation^{a}

| | | | | |
|---|---|---|---|---|
| | P_{CO2} | ΔP_{CO2} | | |
| Membrane | (Barrer)^{b} | (Barrer)^{b} | α_{CO2/CH4} | Δα_{CO2/CH4} |

| | | | | |
|---|---|---|---|---|
| Control 1 | 10.9 | 0 | 23.2 | 0 |
| Control MMM 1 | leaky | | | |
| Control MMM 1, | leaky | | | |
| repeat | | | | |
| MMM 2 | 27.5 | 152% | 25.0 | 8% |

^{a}Tested at 50° C. under 690 kPa (100 psig) pure gas pressure.
^{b}1 Barrer = 10⁻¹⁰ cm³(STP) · cm/cm² · sec · cmHg.

1. A method of making a mixed matrix membrane comprising:
a) dispersing SAPO-34 molecular sieve particles in a solvent mixture to form a molecular sieve slurry wherein said SAPO-34 molecular sieve particles have a Si/Al molar ratio <0.15 and a particle size <500 nm;
b) dissolving a first polymer in the molecular sieve slurry to form a first polymer-functionalized SAPO-34 molecular sieve slurry, wherein said first polymer is used to functionalize the outer surface of the SAPO-34 molecular sieve particles via covalent or hydrogen bonds;
c) dissolving at least one second polymer in said first polymer-functionalized molecular sieve slurry to form a stable first polymer-functionalized SAPO-34 molecular sieve/second polymer suspension; and
d) fabricating a mixed matrix membrane using the stable first polymer-functionalized molecular sieve/second polymer suspension.

2. The method of claim 1 wherein said SAPO-34 molecular sieve particles are fabricated from a low silicon content reactive precursor solution.

3. The method of claim 1 wherein said SAPO-34 molecular sieve particles have a particle size <250 nm.

4. The method of claim 1 wherein said SAPO-34 molecular sieve particles have a particle size <100 nm.

5. The method of claim 1 wherein said SAPO-34 molecular sieve particles are present in a ratio of from 10:1 to 1:2 of said first polymer used to functionalize said SAPO-34.

6. The method of claim 1 wherein said SAPO-34 particles are present at a weight ratio of 1:100 to 1:1 to said polymer that serves as the continuous polymer matrix.

7. The method of claim 1 wherein said first polymer is selected from the group consisting of polyethersulfones, sulfonated polyethersulfones, hydroxyl group-terminated poly(ethylene oxide)s, amino group-terminated poly(ethylene oxide)s, or isocyanate group-terminated poly(ethylene oxide)s, poly(esteramide-diisocyanate)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), polyether ketones, poly(ethylene imine)s, poly(amidoamine)s, poly(vinyl alcohol)s, poly(allyl amine)s, poly(vinyl amine)s, and cellulosic polymers.

8. The method of claim 7 wherein said cellulosic polymers are selected from the group consisting of cellulose acetate, cellulose triacetate, cellulose acetate-butyrate, cellulose propionate, ethyl cellulose, methyl cellulose, and nitrocellulose.

9. The method of claim 1 wherein said first polymer is polyethersulfone.

10. The method of claim 1 wherein said second polymer is selected from the group consisting of polysulfones; polyetherimides; cellulosic polymers; polyamides; polyimides; polyamide/imides; polyether ketones; poly(ether ether ketone)s, poly(arylene oxides); poly(esteramide-diisocyanate); polyurethanes; poly(benzobenzimidazole)s; polyhydrazides; polyoxadiazoles; polytriazoles; poly(benzimidazole)s; polycarbodiimides; polybenzoxazoles; polyphosphazines; microporous polymers; and mixtures thereof.

11. The method of claim 1 wherein said second polymer is selected from the group consisting of polysulfone, polyetherimides, cellulose acetate, cellulose triacetate, polyamides, polyimides, P84 or P84HT, poly(3,3′,4,4′-benzophenone tetracarboxylic dianhydride-pyromellitic dianhydride-3,3′,5,5′-tetramethyl-4,4′-methylene dianiline), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline), poly(3,3′,4,4′-diphenylsulfone tetracarboxylic dianhydride-3,3′,5,5′-tetramethyl-4,4′-methylene dianiline), poly(3,3′,4,4′-benzophenone tetracarboxylic dianhydride-3,3′,5,5′-tetramethyl-4,4′-methylene dianiline), poly(3,3′,4,4′-diphenylsulfone tetracarboxylic dianhydride-pyromellitic dianhydride-3,3′,5,5′-tetramethyl-4,4′-methylene dianiline), poly[2,2′-bis-(3,4-dicarboxyphenyl)hexafluoropropane dianhydride-1,3-phenylenediamine], poly[2,2′-bis-(3,4-dicarboxyphenyl)hexafluoropropane dianhydride-1,3-phenylenediamine-3,5-diaminobenzoic acid)], poly[2,2′-bis-(3,4-dicarboxyphenyl)hexafluoropropane dianhydride-2,2-bis(3-amino-4-hydroxyphenyl)-hexafluoropropane], poly(benzimidazole)s, polybenzoxazoles, and microporous polymers.

12. The method of claim 1 wherein said second polymer is selected from the group consisting of polyimides, polyetherimides, polyamides, polybenzoxazoles, cellulose acetate, cellulose triacetate, and microporous polymers.

13. The method of claim 1 wherein said mixed matrix membrane is a symmetric mixed matrix dense film, a thin-film composite mixed matrix membrane, an asymmetric flat sheet mixed matrix membrane, or an asymmetric hollow fiber mixed matrix membrane.

14. The method of claim 1 further comprising coating said mixed matrix membrane with a material selected from the group consisting of polysiloxanes, fluoropolymers, thermally curable silicone rubbers or UV radiation curable epoxysilicones.

15. The method of claim 1 wherein said mixed matrix membrane is used for a separation selected from the group consisting of deep desulfurization of gasoline or diesel fuels, ethanol/water separations, pervaporation dehydration of aqueous/organic mixtures, or gas separations.

16. The method of claim 1 wherein said gas separation comprises separating gases selected from the group consisting of CO₂/CH₄, CO₂/N₂, H₂/CH₄, O₂/N₂, olefin/paraffin (e.g. propylene/propane), iso/normal paraffins separations, and other light gas mixture separations.
